(19) United States
(12) Patent Application Publication
(10) Pub. No.: US 2003/0088833 A1
(43) Pub. Date: May 8, 2003

(54) Word/phrase display apparatus, spelling checking apparatus and electronic dictionary

(76) Inventors: Kenichi Miyazaki, Chiba-shi (JP); Kazuko Yamanoi, Satte-shi (JP)

Correspondence Address: ADAMS & WILKS, 31st FLOOR, 50 BROADWAY, NEW YORK, NY, 10004, US

(21) Appl. No.: 10/269,249

(22) Filed: Oct. 11, 2002

(30) Foreign Application Priority Data
Oct. 12, 2001 (JP) 2001-315293

(51) Int. Cl. G06F 15/00

(52) U.S. Cl. 715/533

(57) ABSTRACT

A word/phrase display apparatus for handling a language used in wide areas only supported words/phrases of one area, and a plurality of types of apparatuses were necessary even when handling the same language. Spelling difference information corresponding to each area in added to recorded words/phrases in advance and only words/phrases of a designated area are displayed. The designation of an area can be set by a user using an external switch or the like.

### BACKGROUND OF THE INVENTION

1. Field of the Invention

This invention relates to a word/phrase display apparatus for displaying characters.

2. Description of the Related Art

For example, in the case of English, British English and American English partly differ in spelling. Conventionally, for example, as a spelling checking apparatus for checking the spelling of English, there were only apparatuses dedicated for either British English or American English.

Therefore, manufacturers had to manufacture a plurality of types of apparatuses because of a slight difference in spelling, though these apparatuses had substantially the same function. Moreover, it might be difficult for a user who is not a native speaker of English to select which product to be used. This invention can significantly reduce the manufacturing cost and the inventory risk due to the foregoing situation.

### SUMMARY OF THE INVENTION

In order to solve the foregoing problem, a first aspect of this invention resides in a word/phrase display apparatus characterized by comprising, an external input means for carrying out at least character data input and various control input, a word data storage means in which a plurality of words/phrases including words/phrases having spelling difference information are stored, a user selection storage means for storing a user selection inputted from the external input means, a selection control means for selecting a word/phrase corresponding to the user selection stored in the user selection storage means based on the spelling difference information, and a display means for displaying the word/phrase selected by the selection control means.

A second aspect of this invention resides in a spelling checking apparatus characterized by comprising, an external input means for carrying out at least character data input and various control input, a word data storage means in which a plurality of words/phrases including words/phrases having spelling difference information are stored, a user selection storage means for storing a user selection inputted from the external input means, a data search means for comparing character data inputted from the external input means with word/phrase data read out from the word data storage means based on the spelling difference information in accordance with the user selection stored in the user selection storage means, and selecting and extracting a word/phrase having a coincident or approximate spelling, and a display means for displaying the word/phrase.

A third aspect of this invention resides in an electronic dictionary characterized by comprising, an external input means for carrying out at least character data input and various control input, a word data storage means in which a plurality of entries including entries having spelling difference information and data of translations corresponding to the entries are stored, a user selection storage means for storing a user selection inputted from the external input means, a data search means for comparing character data inputted from the external input means with the entries read out from the word data storage means based on the spelling difference information in accordance with the user selection stored in the user selection storage means, and extracting an entry having a coincident spelling, and a display means for displaying the entry.

A fourth aspect of this invention resides in the electronic dictionary of the third aspect characterized in that the spelling difference information is also added at least to the data of translations stored in the word data storage means and translation data corresponding to the user selection is displayed on the display means.

### BRIEF DESCRIPTION OF THE DRAWINGS

FIG. 1 is a flowchart of a function of a spelling checking apparatus of an embodiment according to this invention.

FIG. 2 is a flowchart of spelling format selection of the spelling checking apparatus of the embodiment according to this invention.

FIG. 3 is a functional structural block diagram of the spelling checking apparatus of the embodiment according to this invention.

FIG. 4 is a schematic structural view of the spelling checking apparatus of the embodiment according to this invention.

FIG. 5 shows a first example of a word data list in the spelling checking apparatus of the embodiment according to this invention.

FIG. 6 shows a second example of the word data list in the spelling checking apparatus of the embodiment according to this invention.

FIG. 7 is a view showing a display state of a screen of spelling format selection in the spelling checking apparatus of the embodiment according to this invention.

FIG. 8 is a view showing a display state of a result of spelling checking in the case where British English is selected in the spelling checking apparatus of the embodiment according to this invention.

### DESCRIPTION OF THE PREFERRED EMBODIMENT

This invention enables switching of the format of spelling to be handled in accordance with users selection in a word/phrase display apparatus which handles a broadly used language such that the spellings differ only partly because of the difference in area or the like, for example, like British English and American English.

Hereinafter, an embodiment of a spelling checking apparatus using this invention will be described in detail with reference to the drawings.

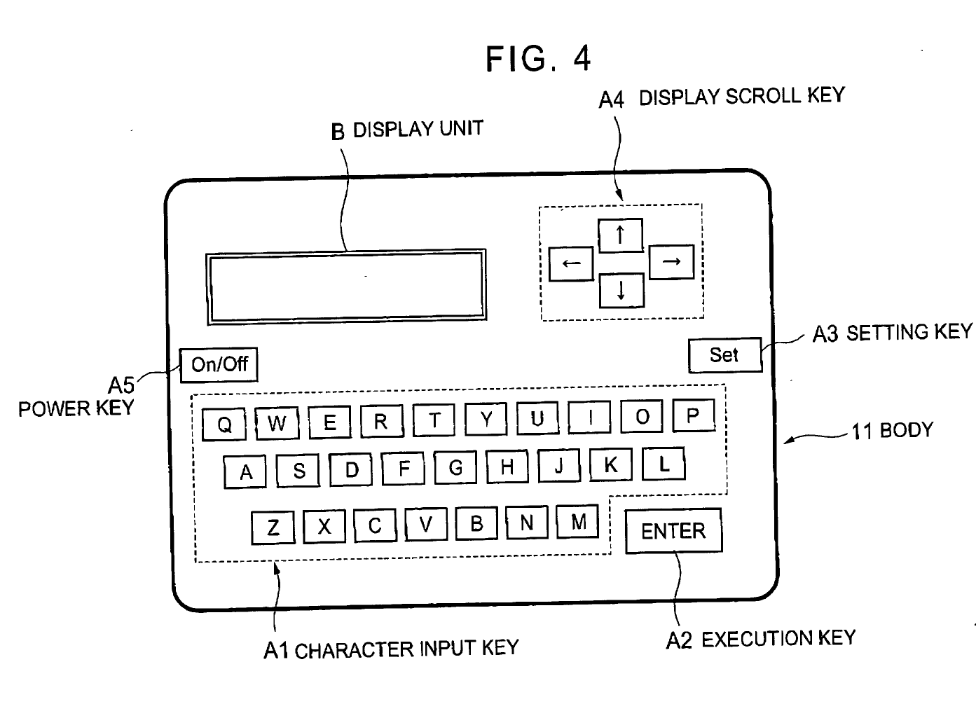

FIG. 4 is a view showing the appearance of a spelling checking apparatus based on an embodiment of this invention.

A character input key A1 is used by a user to input characters such as alphabets. An execution key A2 is used for notifying the apparatus of the decision of an input after the user selection or input of characters or the like. A setting key A3 is used for displaying a mode of each setting on the apparatus when the user wants to carry out each setting of the apparatus. A power key A5 is used by the user to turn on or off the power of the apparatus. All of these are equivalent to external input means.

A display unit B is used for visually displaying the user input or the output of the apparatus and is equivalent to display means.

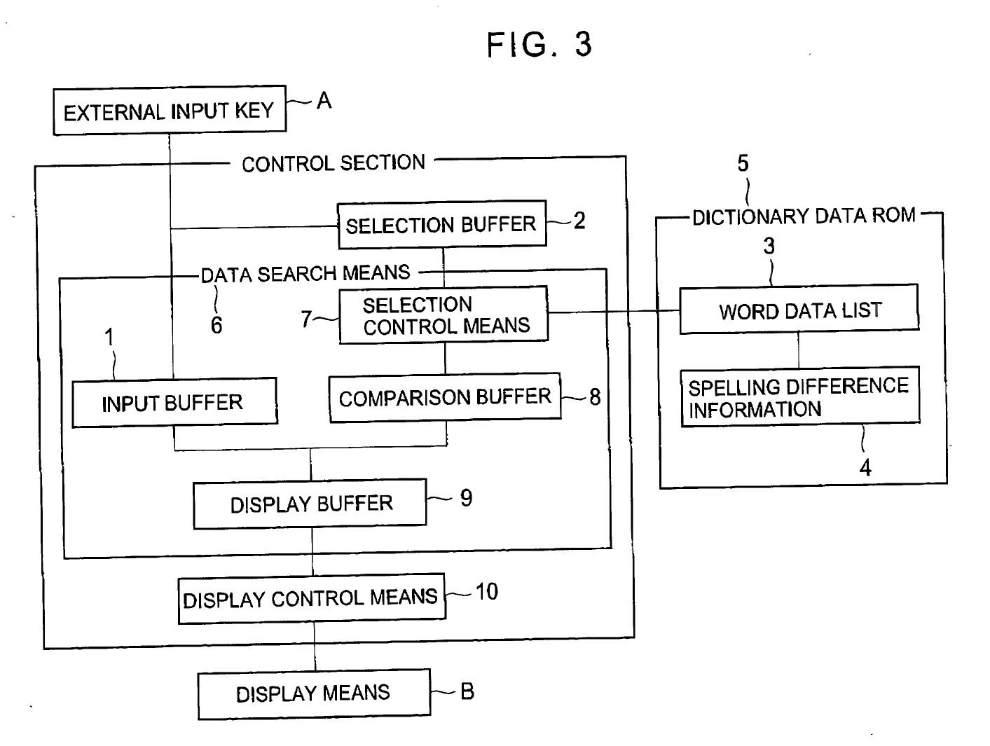

FIG. 3 is a functional structural block diagram of the spelling checking apparatus based on the embodiment of this invention.

In this embodiment, the setting key A3, a display scroll key A4 and the execution key A2 of the external input keys A are used for setting which spelling is used by the user to perform spelling checking, and the result of this setting is stored into a selection buffer 2, which is equivalent to user selection storage means. Moreover, the character input key A1 and the execution key A2 are used for inputting a character string on which the user wants to perform spelling checking, and the result of this is stored into an input buffer 1.

When actually performing spelling checking, data search means 6 takes out a word/phrase to be compared with the word/phrase stored in the input buffer 1, from a word data list 3 in a dictionary data ROM 5. The dictionary data ROM 5 is equivalent to word data storage means.

If spelling difference information 4 has been added to the word/phrase, selection control means 7 transforms the word/phrase to a spelling corresponding to the user selection stored in the selection buffer 2 and stores the transformed word/phrase into a comparison buffer 8. If the spelling difference information 4 has not been added, the word/phrase is stored into the comparison buffer 8 as it is.

The word/phrase which is determined to be approximate or coincident with the word/phrase stored in the input buffer 1 by the data search means 6 as a result of comparison is stored into a display butter 9.

The word/phrase stored in the display buffer 9 is transformed to display data by display control means 10 and displayed on the display means B.

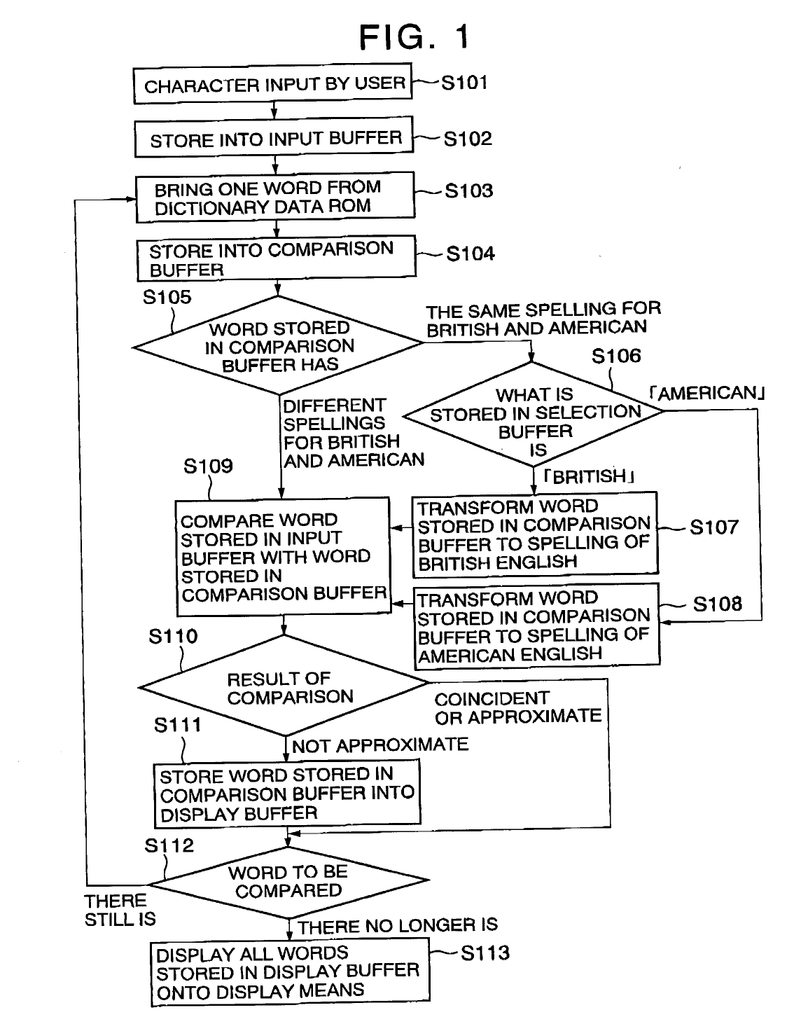

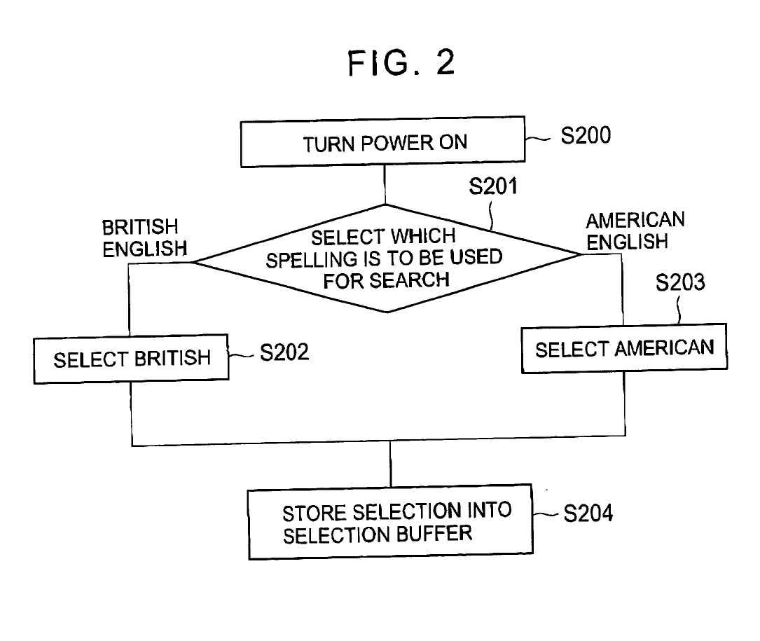

Now, the operation principle in the case of performing spelling checking by using a spelling checking apparatus for English will be specifically described in accordance with the flowcharts of FIGS. 1 and 2.

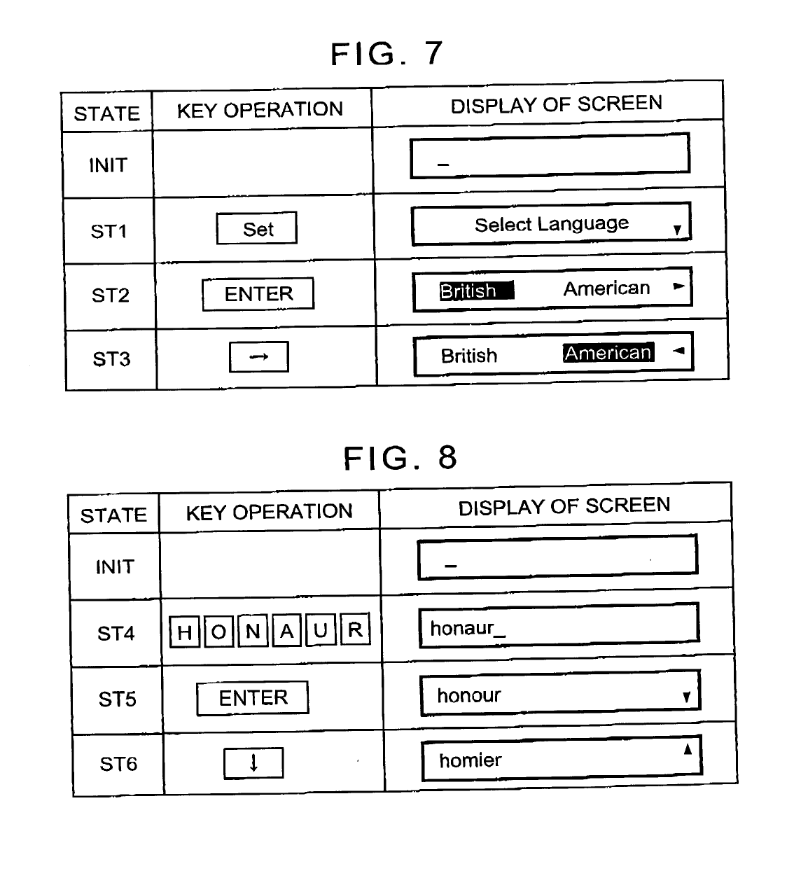

FIGS. 7 and 8 show the state of the display unit at each step.

The user needs to select which of British spelling and American spelling is to be used before carrying out spelling checking in accordance with the procedure shown in the flowchart of FIG. 2.

First, by pressing the setting key A3 in an input standby state (step S200, display: state INIT in FIG. 7) immediately after pressing the power key A5 or the like, the user can carry out each setting in addition to selection of a spelling format to be handled (display: state ST1 in FIG. 7). In this case, the user can select a setting item by using the display scroll key A4 and decide the setting item by using the execution key A2.

Next, the user can select a spelling format by using the display scroll key A4 and decide the spelling format by using the execution key A2 (step S201, display: states ST2 and ST3 in FIG. 7). If the execution key A2 is pressed when the display is in the state ST2 in FIG. 7, the spelling to be handled is set to the British spelling (British English) (step S202). If the execution key A2 is pressed when the display is in the state ST3 in FIG. 7, the spelling to be handled is set to the American spelling (American English) (step S203). The setting is stored into the selection buffer 2 (step S204).

The case where the user carries out spelling checking with a character string “honaur” will now be described with reference to the procedure shown in the flowchart of FIG. 1.

First, a character input “honaur” by the user is obtained from the character input key A1 for inputting alphabets (step S101, display; state ST4 in FIG. 8).

Next, as the user presses the execution key A2, “honaur” is stored into the input buffer 1 (step S102).

Then, the data search means 6 takes out a word/phrase from the word data list 3 stored in the dictionary data ROM 5 (step S103).

The spelling difference information 4 stored in the dictionary data ROM 5 will now be described.

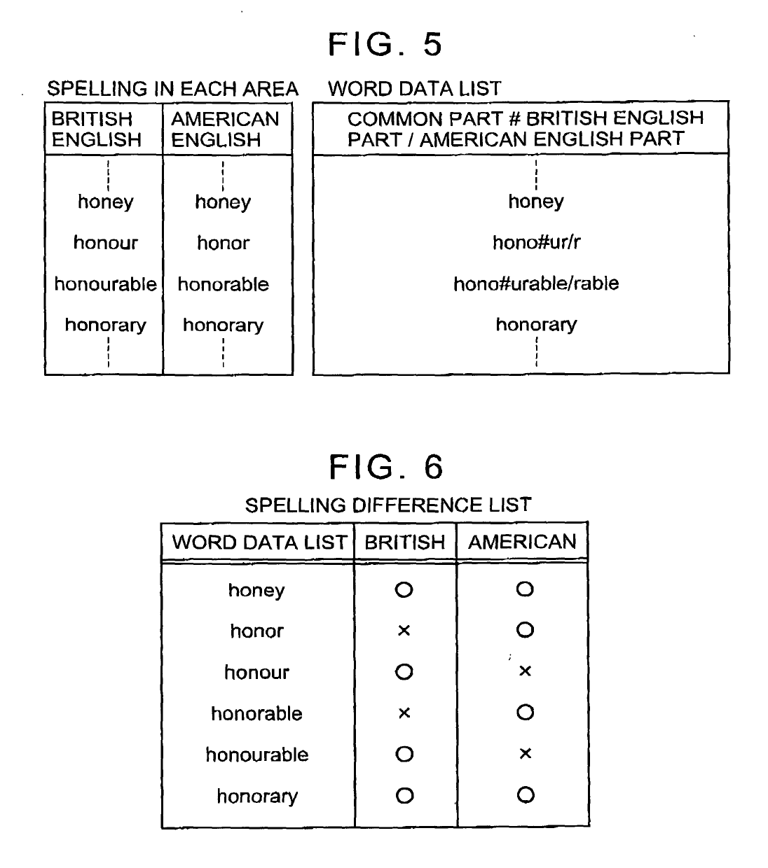

The word data list of FIG. 5 is a part of an example of the spelling in each area and the spelling difference information 4 added in the word data list 3. In this word data list, for a word having partly different spellings for the same word between Britain and the U.S., these spellings are divided into common parts and different parts and special marks “#, 1” are added between these character strings. These special marks “#, 1” are equivalent to the spelling difference information. In this case, the word data list as shown in FIG. 5 need be stored in the dictionary data ROM 5 in advance.

Moreover, as an exemplary list of word data including the spelling difference information 4 stored in the word data list 3, an example as shown in FIG. 6 may be considered. In FIG. 6, first, all the words/phrases of British and American spellings are recorded to the word data list, regardless of the spelling format. Next, a spelling difference list which shows whether each word/phrase has the British spelling or American spelling by using “O” and “X” is added to the foregoing word data list. If the word data list of FIG. 6 is stored in the dictionary data ROM 5, the spelling difference list of FIG. 6 is equivalent to the spelling difference information.

The structure of the dictionary data ROM 5 may be any structure having an efficient memory capacity and therefore is not limited to these techniques.

It is now assumed that word/phrase data taken out from the word data list 3 is “hono#ur/r”.

After the word/phrase data is taken out from the dictionary data ROM 5, the word/phrase data “hono#ur/r” is stored into the comparison buffer 8 (step S104).

Next, whether or not the word/phrase data stored in the comparison buffer 8 has a common spelling for British and American English is determined (step S105). If it is determined that the word/phrase data has a common spelling, the word/phrase data stored in the input butter 1 is compared with the word/phrase data stored in the comparison buffer 8 (to step S109). In this embodiment, since the word/phrase data “hono#ur/r” stored in the comparison buffer 8 includes “#, /” it is determined that the word/phrase has difference spellings for British and American English (to step S106).

Then, the selection control means 7 confirms the content stored in the selection buffer 2 (step S106).

If the content stored in the selection buffer 2 is “British”, “honour” is selected by the selection control means 7 and stored again into the comparison buffer 8 (step S107).

If the content stored in the selection buffer 2 is “American”, “honor” is selected by the selection control means 7 and restored again into the comparison buffer 8 (step S108).

When British English is selected, “honor” is not used. Similarly, when American English is selected, “honour” is not used.

Next, the data search means 6 compares “honaur” stored in the input buffer 1 with “honour” (or “honor”) stored in the comparison buffer 8 (step S109).

If it is determined by the data search means 6 at step S110 that the words/phrases are not approximate or coincident with each other as a result of this comparison, the data search means 6 determines whether there is any word/phrase to be compared next, in the word data list 3 (to step S112). In this embodiment, it is assumed that the data search means 6 determines that “honaur” stored in the input buffer 1 and “honour” (or “honor”) stored in the comparison buffer 8 are approximate words/phrases (to step S111).

The word honour (or honor), which is determined by the data search means 6 as an approximate or coincident word/phrase as a result of the comparison at step S109, is stored into the display buffer 9 (step S111).

Then, the data search means 6 determines whether there still is any word/phrase data to be compared with “honaur” stored in the input buffer 1, in the word data list 3 (step S112). If it is determined that there still is a word/phrase data to be compared, the data search means 6 takes out the next word/phrase from the word data list 3 stored in the dictionary data ROM 5 (to step S103). If there no longer is any word/phrase to be compared, the comparison of words/phrases ends (to step S113).

The data search means 6 carries out the process of the foregoing steps S103 to S112.

Other than “honour” (or honor) stored in the display buffer 9, a word/phrase which is determined by the data search means 6 as an approximate or coincident word/phrase as a result of the comparison at step S109 is displayed on the display means B by using the display control means 10 (step S113, state ST5 in FIG. 8). When there are a plurality of approximate words, the plurality of words are stored into the display buffer 9 and the other approximate words can be displayed by using the display scroll key A4 (state ST6 in FIG. 8).

While the foregoing is the embodiment of the spelling checking apparatus, the technique can also be carried out in a word/phrase display apparatus which displays a word/phrase corresponding to users selection, of word data storing a plurality of words/phrases including words/phrases having the above-described spelling difference information in advance.

Moreover, the technique can also be carried out in an electronic dictionary in which a plurality of entries and meaning texts including words/phrases having the above-described spelling difference information 4 are stored in the word data in advance so as to search these entries and meaning texts.

As described above, according to this invention, since means for enabling the user to select which area's word/phrase is to be used is provided for the recorded words/phrases in advance, the function using only the word/phrase of the area required by the user can be executed. Therefore, a word/phrase display apparatus which is applicable to users of a plurality of areas with a single type of apparatus can be provided and the manufacturing cost and the inventory risk in developing products for a plurality of areas can be significantly reduced.

What is claimed is:

1. A word/phrase display apparatus comprising:
an external input means for carrying out at least character data input and various control input;
a word data storage means in which a plurality of words/phrases including words/phrases having spelling difference information are stored;
a user selection storage means for storing a user selection inputted from the external input means;
a selection control means for selecting a word/phrase corresponding to the user selection stored in the user selection storage means based on the spelling difference information; and
a display means for displaying the word/phrase selected by the selection control means.

2. A spelling checking apparatus comprising:
an external input means for carrying out at least character data input and various control input;
a word data storage means in which a plurality of words/phrases including words/phrases having spelling difference information are stored;
a user selection storage means for storing a user selection inputted from the external input means;
a data search means for comparing character data inputted from the external input means with word/phrase data read out from the word data storage means based on the spelling difference information in accordance with the user selection stored in the user selection storage means, and selecting and extracting a word/phrase having a coincident or approximate spelling; and
a display means for displaying the word/phrase.

3. An electronic dictionary comprising:
an external input means for carrying out at least character data input and various control input;
a word data storage means in which a plurality of entries including entries having spelling difference information and data of translations corresponding to the entries are stored;
a user selection storage means for storing a user selection inputted from the external input means;
a data search means for comparing character data inputted from the external input means with the entries read out from the word data storage means based on the spelling difference information in accordance with the user selection stored in the user selection storage means, and extracting an entry having a coincident spelling; and
a display means for displaying the entry.

4. An electronic dictionary according to claim 3, wherein the spelling difference information is also added at least to the data of translations stored in the word data storage means and translation data corresponding to the user selection is displayed on the display means.
